(19) United States
(12) Patent Application Publication
(10) Pub. No.: US 2015/0373934 A1
(43) Pub. Date: Dec. 31, 2015

(54) IRRIGATION DEVICE AND METHOD OF PROMOTING DEEP ROOT GROWTH OF A PLANT

(71) Applicant: DEEP ROOT IRRIGATION, LLC, Angwin, CA (US)

(72) Inventor: Jeffrey Ciudaj, Angwin, CA (US)

(21) Appl. No.: 14/318,480

(22) Filed: Jun. 27, 2014

(51) Int. Cl. A01G 29/00; A01G 25/06

(52) U.S. Cl. CPC A01G 29/00; A01G 25/06

(57) ABSTRACT

An irrigation device for promoting deep root growth of a plant. The device may comprise: a tube and a hose. The first end of the tube may connect to a water source. A second end of the tube may be substantially confined within the hose. The tube may pass through a first end of the hose. The first end of the hose may be closed around the tube, such that the tube may be kept substantially in place and such that water from the water source may be substantially prevented from exiting out of the first end of the hose. The second end of the hose may be closed, such that water from the water source may be prevented from exiting out of the second end of the hose. The hose may comprise a plurality of perforations that allow water to seep out of the hose.

### FIELD OF INVENTION

The present disclosure generally relates to a device and method for promoting the downward growth of the roots of a plant. More particularly, the present disclosure generally relates to a device and method that provides deep root watering of a plant and promotes the growth of the roots of a plant deeper into the ground. The device may be connectable to an existing irrigation drip line system. The device may also repel the roots of the plant away from the apparatus, so that the strengthened roots are hindered from destroying the apparatus.

### BACKGROUND

For thousands of years, farmers and, more specifically, viticulturists have generally been irrigating plants and vines to provide for a controlled and consistent growth in the face of inconsistent weather patterns. More recently, farmers have also adopted a system of drip irrigation that generally allows each and every vine in a field to be individually watered efficiently without water wasting sprinklers. However, this drip irrigation system typically provides water only the top of the soil, which generally fails to penetrate deep into the soil. As a result, roots of the vines or plants remain near the surface of the soil, rather than burrowing deep down into the soil, as preferred for a healthy and hardy plant. When a vine or plant has deep roots, the plant is usually better able to find its own supply of water in the lower water table. This in turn allows the plant to survive harsh weather conditions, such as extreme cold, extreme heat, flooding, or drought.

Several references attempt to overcome the problems with drip irrigation by providing an underground source of irrigation water to the plants. One type of underground irrigation system includes references that disclose ways to regulate water. U.S. Pat. No. 4,453,343, issued to Grimes; U.S. Pat. No. 6,540,436, issued to Ogi; and U.S. Pat. No. 5,938,372, issued to Lichfield, are three such references. Other references disclose irrigation systems that define types of holes, such as, U.S. Pat. No. 6,443,367, issued to Bova (which has a screw top hole), U.S. Published Patent Application No. 2003/0196375, filed by Ferro (which discloses multiple holes), and U.S. Pat. No. 5,996,279, issued to Zayeratabat (which discloses holes with a closeable lid).

These references, which share some common features, disclose irrigation systems that attempt to provide deep root irrigation water to a plant. However, these references do not overcome all of the problems of the standard drip irrigation system, and importantly, none of these references disclose a solution that can take advantage of an existing drip irrigation system by directly connecting to the existing drip irrigation system.

Another reference that discloses devices and methods for deep root irrigation systems is U.S. Pat. No. 8,381,437 (“the '437 Patent”), issued to Jeffrey Ciudaj, who is the same inventor of the present disclosure. The contents of the '437 Patent are expressly incorporated herein by this reference as though set forth in their entirety. The '437 Patent discloses a device and method for providing irrigation water to a plant that promotes the growth of the roots of the plant deep into the soil. The irrigation device disclosed in the '437 Patent may connect to an existing irrigation drip line system that previously provided water to the plant and may repel the roots of the plant away from the apparatus so that the roots are hindered from destroying the apparatus.

Although the '437 Patent was a vast improvement over using the standard irrigation systems, it was not optimally efficient in distributing water to the plants being irrigated.

Thus, what is needed a new and improved, efficient deep root irrigation system that can connect to the existing drip irrigation system that was previously installed.

### SUMMARY OF THE INVENTION

To minimize the limitations in the prior art, and to minimize other limitations that will become apparent upon reading and understanding the present specification, the following discloses a device and method for providing irrigation water to a plant that encourages the development of deep root growth and that is connectable to the existing drip irrigation system.

One embodiment may be an irrigation device comprising: a tube and a hose; wherein a first end of the tube is configured to connect to a water source; wherein at least a portion of the tube extends into and is substantially surrounded by the hose and wherein a second end of the tube is substantially confined within the hose; wherein the tube passes through a first end of the hose and wherein the first end of the hose is closed around the tube, such that the tube is kept substantially in place and such that water from the water source is substantially prevented from exiting out of the first end of the hose; wherein the second end of the hose is closed, such that water from the water source is substantially prevented from exiting out of the second end of the hose; and wherein the hose comprises a plurality of perforations that allow water from the water source to seep out of the hose. The hose may be configured to be completely buried underground. The second end of the tube may be substantially near the second closed second end of the hose. The irrigation device may further comprise a copper element. The copper element may be connected to the second end of the tube and is enclosed within the hose. The irrigation device may be buried next to a plant such that one or more roots of the plant grow downward towards a bottom of the irrigation device. The second end of the tube may be substantially near the second closed second end of the hose. The irrigation device may further comprise a copper element. The copper element may be connected to the second end of the tube and is enclosed within the hose.

Another embodiment may be an irrigation device comprising: a tube; a first plug; a second plug; and a hose; wherein the tube comprises: a first end, a second end, an upper portion and a lower portion; wherein the first end of the tube is configured to connect to a water source; wherein the lower portion of the tube extends into and is substantially surrounded by the hose and wherein the second end of the tube is substantially confined within the hose; wherein the first plug is connected to a first end of the hose and wherein the first plug substantially surrounds the tube, such that the lower portion of the tube is held firmly in place within the hose and wherein the upper portion of the tube is outside the hose; wherein the second plug is connected to a second end of the hose; wherein the first plug and the second plug substantially prevent water traveling from the water source from exiting out of the first end and the second end of the hose; and wherein the hose comprise a plurality of perforations that allow water from the water source to seep out of the hose. The hose may be configured to be completely buried underground. The second end of the tube may be substantially near the second closed second end of the hose. The irrigation device may further comprise a copper element. The copper element may be connected to the second end of the tube and may be enclosed within the hose. The irrigation device may be buried next to a plant such that one or more roots of the plant grow downward towards a bottom of the irrigation device. The first plug and the second plug may be permanently attached to the hose. The first plug and the second plug may be removeably attached to the hose. The hose may be buried in a substantially vertical manner. The irrigation device may be buried by digging a hole in the ground, placing the irrigation device in the hole in the ground, and backfilling the hole with an aerating composition.

Another embodiment may be an irrigation device comprising: a tube; a first plug; a second plug; a hose; and a copper element; wherein the tube comprises: a first end, a second end, an upper portion and a lower portion; wherein the first end of the tube is configured to connect to a water source; wherein the lower portion of the tube extends into and is substantially surrounded by the hose and wherein the second end of the tube is substantially confined within the hose; wherein the hose is configured to be completely buried underground; wherein the first plug is connected to a first end of the hose and wherein the first plug substantially surrounds the tube, such that the lower portion of the tube is held firmly in place within the hose and wherein the upper portion of the tube is outside the hose; wherein the second plug is connected to a second end of the hose; wherein the second end of the tube is substantially near the second plug; wherein the first plug and the second plug substantially prevent water traveling from the water source from exiting out of the first end and the second end of the hose; wherein the copper element is connected to the second end of the tube and is enclosed within the hose; wherein the hose comprise a plurality of perforations that allow water from the water source to seep out of the hose; wherein the irrigation device is buried next to a plant such that one or more roots of the plant grow downward towards a bottom of the irrigation device; wherein the hose is buried in a substantially vertical manner; and wherein the irrigation device is buried by digging a hole in the ground, placing the irrigation device in the hole in the ground, and backfilling the hole with an aerating composition.

The method may further comprise: back-filling the hole with gravel or sand to provide additional aeration of the soil.

It is an object to provide a methods and devices for encouraging the growth of plants roots in a downward direction deeper into the soil.

It is another object to incorporate an existing irrigation system with the watering apparatus device and/or enhanced watering method.

It is another object to provide an irrigation system that saves and preserves water.

It is another object to provide an irrigation system to help increase the efficiency of water distribution.

It is another object to provide an irrigation system that is organic compliant.

It is yet another object of the present invention to overcome the limitations of the prior art.

### BRIEF DESCRIPTION OF THE DRAWING

The drawings are of illustrative embodiments, but do not depict all embodiments. Other embodiments may be used in addition to or instead of the illustrative embodiments. Details that may be apparent or unnecessary may be omitted for the purpose of saving space or for more effective illustrations. Some embodiments may be practiced with additional components or steps and/or without some or all components or steps provided in the illustrations. When different drawings contain the same numeral, that numeral refers to the same or similar components or steps.

FIG. 1 is an illustration of a cutaway perspective view of one embodiment of the irrigation device.

FIG. 2 is an illustration of a cutaway perspective view of another embodiment of the irrigation device.

FIG. 3 is an illustration a cutaway perspective view of another embodiment of the irrigation device.

FIG. 4 is an illustration of a cutaway perspective view of another embodiment of the irrigation device and shows the ends of the hose sealed and/or crimped to prevent the water from exiting out the ends of the hose.

### DETAILED DESCRIPTION OF THE DRAWING

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

Although one specific embodiment is disclosed, still other embodiments of the present invention will become apparent to those skilled in the art from the following detailed description, which shows and describes only one illustrative embodiment of the invention. As will be realized, the invention is capable of modifications in various obvious aspects, all without departing from the spirit and scope of the present invention. Accordingly, this one figure is to be regarded as merely illustrative in nature and not restrictive. Also, the reference or non-reference to a particular embodiment of the invention shall not be interpreted to limit the scope of the invention.

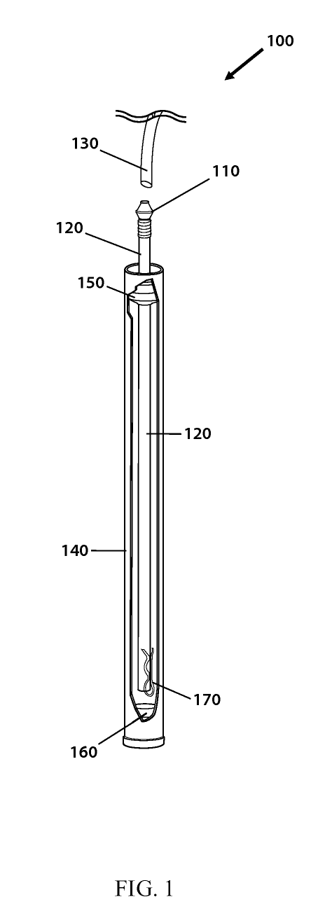

FIG. 1 is an illustration of a cutaway perspective view of one embodiment of the irrigation device. As shown in FIG. 1, one embodiment of the irrigation device 100 may comprise: a coupler 110, a first tube 120, a second tube 130, a hose 140, a first plug 150, a second plug 160, and a copper element 170. FIG. 1 shows that the first tube 120 may be configured to connect to the second tube 130 via a coupler 110. The coupler 110 may be a connector used to connect the first tube 110 to the second tube 130 and may be positioned at the first end or upper end of the first tube 110. In a preferred embodiment, the coupler 110 may be a barbed connector with barb fittings. In one embodiment, the first tube 120, and/or second tube 130 may be a ¼″ irrigation line of various lengths. The first end or upper end of the second tube 130 may be connected to—or otherwise part of—an existing irrigation drip line emitter, and the hose 140 may be a soaker hose, sheath, or shroud. The hose 140 may also be adjusted in various lengths. It should be understood that the irrigation device may be combined with any source of water or other nutrient providing system.

The second tube 130 may extend from a source of water, which is usually above ground and may be an existing drip irrigation system. The second tube may continue underground in a substantially vertical manner and then connect to the first tube 120. Specifically, the second end or lower end of the second tube 130 may be configured to connect to the first end or upper end of the first tube 110 via the coupler 110. The coupler 110 may be above or below ground. When the irrigation system 100 is connected to a source of water, and that source of water is turned on, water may travel from the source of water, typically an existing irrigation drip line emitter, pass through the second end or lower end of the first tube 120, and fill inside the hose 140. The water may also pass through any valves, if needed, which may regulate the water flow between the irrigation drip, the second tube 130, and the first tube 120. The valves, if any, may also prevent the back flow of water. The first tube 120 and the second tube 130 may be constructed from an natural or man-made material, including, but not limited to High-Density Polyethylene (“HDPE”), Medium-Density Polyethylene (“MDPE”), copper, iron, or lead pipes, thermoplastic polymers like Polyvinyl chloride (“PVC”), Chlorinated polyvinyl chloride (“CPVC”), Acrylonitrile butadiene styrene (“ABS”), cross-linked polyethylene (“PEX plastic”) pressure pipes, or any other similar material that can assist to resist mold, corrosion, and weather damage. If desired, a pressure control valve may also be installed to regulate water pressure and help prevent excessive pressure from harming the system.

The irrigation device 100 may be assembled and then placed in a hole in the ground adjacent to the plant or vine to be irrigated. The hole in the ground may be a deep and substantially vertical hole that can accommodate the length of the hose 140, first tube 120, and/or second tube 130. The irrigation device 100 also may be buried deep enough, so that roots of the plant being irrigated will strive to get to the water provided by device 100.

The copper element 170 is generally any piece of copper that may be positioned at the second end or lower end of the first tube 120 and is generally near the lower end of the hose 140. In addition to repelling roots from growing into first tube 120, the copper element 170 may also function as a catalyst in photosynthesis and respiration. By incorporating a copper element 170, the roots of a plant that the irrigation device 100 is watering may be prevented from growing out of control and choking the irrigation device 100. In a preferred embodiment, the copper element 170, which may be attached to the bottom or second end of the first tube 120, as shown in FIG. 1, may also substantially prevent the roots of the plant from destroying the hose 140, first tube 120, and/or second tube 130 or clogging the water supply exiting the first tube 120. In an embodiment, the copper element 170 may be a standard hose coupling that attaches to the first tube 120. The copper element 170 may be any shape, such a clip (as shown), cylinder, U-bend, V-bend, ninety (90) degree bend, or straight.

The hose 140 may be a soaker hose, sheath, shroud, liquid-permeable membrane, or other type of perforated hollow hose that has small holes or perforations, which may allow the water to seep out of the hose 140 as it travels up the length of the hose 140. Specifically, the water may pass through the first tube 120, and/or second tube 130 and then start to fill the hose 140. The water may then seep out of the hose 140 into the ground around the hose 140. The water generally first seeps out of the hose 140 at the deepest part of the hose 140. If the water exiting from the first tube is at a high enough flow rate, then the water, in addition to seeping out of the perforations of the hose 140 at the bottom, may travel upward along the length of the hose and form a column of water around the device 100. Generally, the hose 140 will have more water seeping out of the bottom and less water seeping out of the top when water is flowing.

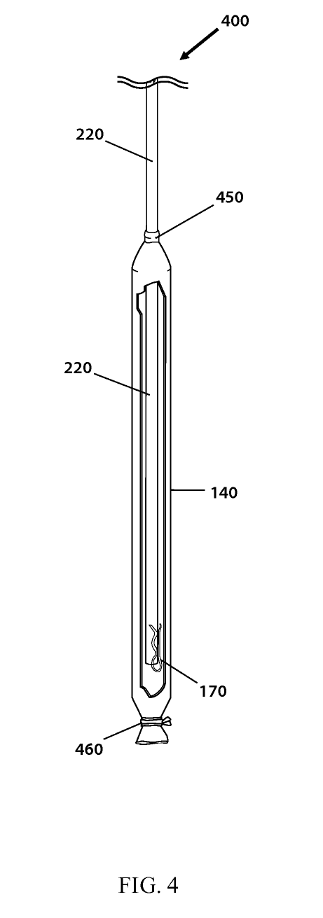

The hose 140 may have a first plug 150, which is generally configured to connect the first tube 120 to the hose 140 and may be used to plug, stop, or cap the upper end of the hose 140 to prevent water from exiting out of the top of the hose 140 and gushing upwards. In an embodiment, as shown in FIG. 1, the first plug 150 may be a ribbed and/or cylindrical plug that allows the first tube 120 to pass through the hose 140 and plug the hose 140. On the other hand, the second plug may be configured to stop or cap the lower end of the hose 140 to force water to exit out of the holes of the hose 140. Like the first plug 150, the second plug 160 may be a ribbed and/or cylindrical plug that stops and plugs at the bottom end of the hose 140, as shown in FIG. 1. Alternatively, and as shown in FIG. 4, the hose 140 may simply be tied off, sealed, glued, crimped, or otherwise plugged, to prevent the water from exiting out the end of the hose 140.

The water may first exit the hose 140 out of perforations, and depending upon how much water is provided to the irrigation device 100, more water may be provided through the holes or perforations that are higher up on the hose 140. When the irrigation device 100 is first installed, more water may be provided, so that the roots of a plant sense the water and begin growing deeper immediately. A column of water saturated soil may be created along the hose 140, which may allow the roots to grow downwards to and through the saturated soil and towards the hose 140. In a preferred embodiment, the saturated column of soil never reaches the surface of the soil, thereby preventing loss of water to evaporation. Additionally, the copper element 170 may be placed near the lowest position in the irrigation device 100, and may be positioned inside the hose 140.

When the irrigation device 100 is placed inside the hole in the ground, the hole in the ground may be back filled with an aerating composition, such as gravel or sand to provide additional aeration of the soil. The hole in the ground may also be backfilled with any composition, so long as the irrigation device 100 is held in substantially in place and may provide water to plant being irrigated.

When the irrigation device 100 is used, a moist column of soil may be created that is substantially deeper and more effective than what can be created by a standard drip irrigation system or sprinkler system. By creating deeper roots, the plant may be able to better survive harsh weather, such as extreme heat, cold, unseasonable weather, drought, flooding, or excessive rainfall. Plants without deep roots are much less likely to survive harsh weather.

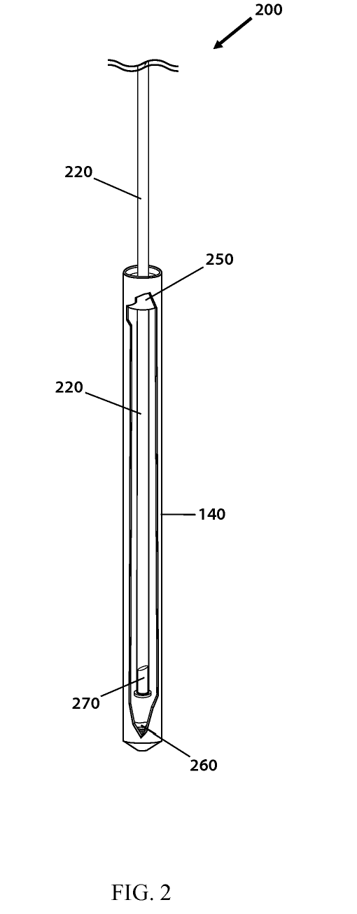

FIG. 2 is an illustration of a cutaway perspective view of another embodiment of the irrigation device. As shown in FIG. 2, another embodiment of the irrigation device 200 may comprise: a tube 220, a hose 140, a first plug 250, a second plug 260, and a copper element 270. One end of the tube 220, which is generally the first end or upper end of the tube 220, may be connected to an existing irrigation drip line emitter. The second end or lower end of the tube is generally located inside the hose 140. In an embodiment, the tube 220 may also be a ¼″ irrigation line of various lengths. It should be understood that the irrigation device may be combined with any source of water or other nutrient providing system. The irrigation device 200 is similar to irrigation device 100, but has different plugs 250, 260, a different copper element 270, and has a single tube 220.

The hose 140 may have a first plug 250, which is generally configured to connect the tube 220 to the hose 140 and may be used to stop or cap the upper end of the hose 140 to force water to exit out of the perforations. In an embodiment, as shown in FIG. 2, the first plug 250 may be a rubber plug and may be glued to hold the first plug 250 to the hose 140. Additionally, the first plug 250 may allow the tube 220 to pass through and may allow the first plug 250 to snugly fit tight inside the hose 240. Additionally, the second plug 260 may be configured to stop or cap the lower end of the hose 140 to force water to exit out of the perforations. Like the first plug 250, the second plug 260 may plug the second or bottom end of the hose 140 as a hot melted glue plug formed in an aluminum cap mold. FIG. 2 also shows that the copper element 270 may be placed near the lowest position in the irrigation device 200, and may be positioned at the end of the tube 220 and inside the hose 140.

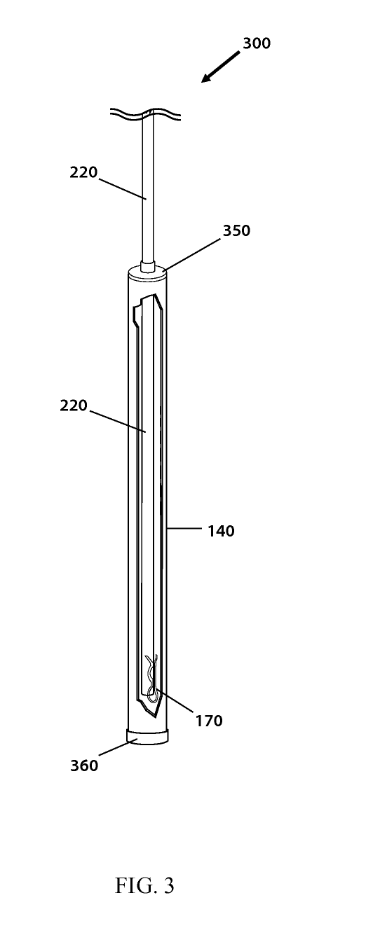

FIG. 3 is an illustration a cutaway perspective view of another embodiment of the irrigation device. As shown in FIG. 3, another embodiment of the irrigation device 300 may comprise: a tube 220, a hose 140, a first plug 350, a second plug 360, and a copper element 170.

The hose 140 may have a first plug 350, which is generally configured to connect the tube 220 to the hose 140 and may be used to stop or cap the upper end of the hose 140 to force water to exit out of the perforations. In another embodiment, the first plug 350 may be a melted, hot tipping dye mold to seal the hose 140 and around the tube 220. Additionally, the second plug 360 may be configured to stop or cap the lower end of the hose 340 to force water to exit out of the perforations.

FIG. 4 is an illustration of a cutaway perspective view of another embodiment of the irrigation device and shows the ends of the hose sealed and/or crimped to prevent the water from exiting out the ends of the hose. As shown in FIG. 4, another embodiment of the irrigation device 400 may comprise: a tube 220, a hose 140, and a copper element 170, wherein the hose 140 generally has a first end 450 and a second end 460. FIG. 4 shows that the first end 450 and the second end 460 of the hose 140 may be sealed without a plug. Specifically, as shown in FIG. 4, the first end 450 may be sealed and glued while the second end 460 may be tied off or crimped.

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. The invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope of the invention. It is intended that the scope of the invention not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. An irrigation device comprising:
a tube; and
a hose;
wherein a first end of said tube is configured to connect to a water source;
wherein at least a portion of said tube extends into and is substantially surrounded by said hose and wherein a second end of said tube is substantially confined within said hose;
wherein said tube passes through a first end of said hose and wherein said first end of said hose is closed around said tube, such that said tube is kept substantially in place and such that water from said water source is substantially prevented from exiting out of said first end of said hose;
wherein said second end of said hose is closed, such that water from said water source is substantially prevented from exiting out of said second end of said hose; and
wherein said hose comprises a plurality of perforations that allow water from said water source to seep out of said hose.

2. The irrigation device of claim 1, wherein said hose is configured to be completely buried underground.

3. The irrigation device of claim 1, wherein said second end of said tube is substantially near said second closed second end of said hose.

4. The irrigation device of claim 1, further comprising a copper element.

5. The irrigation device of claim 4, wherein said copper element is connected to said second end of said tube and is enclosed within said hose.

6. The irrigation device of claim 2, wherein an irrigation device is buried next to a plant such that one or more roots of said plant grow downward towards a bottom of said irrigation device.

7. The irrigation device of claim 6, wherein said second end of said tube is substantially near said second closed second end of said hose.

8. The irrigation device of claim 7, further comprising a copper element.

9. The irrigation device of claim 8, wherein said copper element is connected to said second end of said tube and is enclosed within said hose.

10. An irrigation device comprising:
a tube;
a first plug;
a second plug; and
a hose;
wherein said tube comprises: a first end, a second end, an upper portion and a lower portion;
wherein said first end of said tube is configured to connect to a water source;
wherein said lower portion of said tube extends into and is substantially surrounded by said hose and wherein said second end of said tube is substantially confined within said hose;
wherein said first plug is connected to a first end of said hose and wherein said first plug substantially surrounds said tube, such that said lower portion of said tube is held firmly in place within said hose and wherein said upper portion of said tube is outside said hose;
wherein said second plug is connected to a second end of said hose;
wherein said first plug and said second plug substantially prevent water traveling from said water source from exiting out of said first end and said second end of said hose; and
wherein said hose comprise a plurality of perforations that allow water from said water source to seep out of said hose.

11. The irrigation device of claim 10, wherein said hose is configured to be completely buried underground.

12. The irrigation device of claim 10, wherein said second end of said tube is substantially near said second closed second end of said hose.

13. The irrigation device of claim 10, further comprising a copper element.

14. The irrigation device of claim 13, wherein said copper element is connected to said second end of said tube and is enclosed within said hose.

15. The irrigation device of claim 11, wherein said irrigation device is buried next to a plant such that one or more roots of said plant grow downward towards a bottom of said irrigation device.

16. The irrigation device of claim 11, wherein said first plug and said second plug are permanently attached to said hose.

17. The irrigation device of claim 11, wherein said first plug and said second plug are removeably attached to said hose.

18. The irrigation device of claim 15, wherein said hose is buried in a substantially vertical manner.

19. The irrigation device of claim 18, wherein said irrigation device is buried by digging a hole in the ground, placing said irrigation device in said hole in the ground, and backfilling said hole with an aerating composition.

20. An irrigation device comprising:
a tube;
a first plug;
a second plug;
a hose; and
a copper element;
wherein said tube comprises: a first end, a second end, an upper portion and a lower portion;
wherein said first end of said tube is configured to connect to a water source;
wherein said lower portion of said tube extends into and is substantially surrounded by said hose and wherein said second end of said tube is substantially confined within said hose;
wherein said hose is configured to be completely buried underground;
wherein said first plug is connected to a first end of said hose and wherein said first plug substantially surrounds said tube, such that said lower portion of said tube is held firmly in place within said hose and wherein said upper portion of said tube is outside said hose;
wherein said second plug is connected to a second end of said hose;
wherein said second end of said tube is substantially near said second plug;
wherein said first plug and said second plug substantially prevent water traveling from said water source from exiting out of said first end and said second end of said hose;
wherein said copper element is connected to said second end of said tube and is enclosed within said hose;
wherein said hose comprise a plurality of perforations that allow water from said water source to seep out of said hose;
wherein said irrigation device is buried next to a plant such that one or more roots of said plant grow downward towards a bottom of said irrigation device;
wherein said hose is buried in a substantially vertical manner; and
wherein said irrigation device is buried by digging a hole in the ground, placing said irrigation device in said hole in the ground, and backfilling said hole with an aerating composition.
